(19) United States
(12) Patent Application Publication
(10) Pub. No.: US 2006/0145655 A1
(43) Pub. Date: Jul. 6, 2006

(54) Car battery jumper cable apparatus

(75) Inventor: Hsien-Fang Sheng, Taipei (TW)

Correspondence Address: DELLETT & WALTERS, P. O. BOX 82788, PORTLAND, OR, 97282-0788, US

(73) Assignee: DHC SPECIALTY CORP.

(21) Appl. No.: 11/029,142

(22) Filed: Jan. 3, 2005

(51) Int. Cl. H02J 7/00; H02J 7/14

(52) U.S. Cl. 320/105

(57) ABSTRACT

A car battery jumper cable apparatus for examining whether polarity of a supplementary battery and an exhausted car battery is correctly connected. The jumper cable apparatus includes a relay, a relay driving circuit, a battery polarity recognition circuit, a signal oscillator, an alarm circuit of reverse battery polarity, an indicator light for discharged battery connection, and an indicator light for recharged battery connection. In addition, the signal oscillator will control a battery recharge procedure according to immediate recharged current status, so as to provide secure protection for recharge.

### BACKGROUND OF THE INVENTION

1. Field of the Invention

The invention relates in general to a car battery jumper cable apparatus, and more particularly to a car battery jumper cable apparatus having an alarm for indicating a reversed battery polarity.

2. Description of the Related Art

When using a conventional jumper cable, a polarity connection between a supplementary power source and an exhausted car battery must be accurately confirmed. In case of a polarity connection error, the car battery and the parts of a car may be damaged or burned out, which may even result in a catastrophe. Two conductors of the jumper cable are generally marked with different colors or different symbols for quick recognition. However, if the color marks or the symbols are covered with dirt or the jumper cable is used at night or in an insufficient light environment, the user may be unable to accurately recognize the polarity of the jumper cable. In such a case, a connection error may occur.

Referring to FIG. 3 of the present application, U.S. Pat. No. 4,769,586 discloses a jumper cable apparatus, which can automatically recognize a polarity of a first battery 12 and a polarity of a second battery 14. This structure of the jumper cable apparatus comprises two conductor pairs 16 and 18 for connection between the two batteries 12 and 14.

When installed, the jumper cable apparatus makes identification to the polarity of the batteries 12 and 14 based on the current in the conductor pairs 16 and 18 to perform a switching operation. If the identification is successful, the two poles of the first battery 12 will be accurately coupled to the two poles of the second battery 14. Since this jumper cable apparatus 10 recognizes the polarity by means of detecting the voltage at the conductor pairs 16 and 18, the jumper cable apparatus 10 must periodically detect the current at the conductor pairs 16 and 18, and use a complex switching circuit to switch a plurality of relays 36 during detection. In addition, the reaction of this structure of the jumper cable apparatus is slow and takes too much time to detect the connection of the clips 22,23,24,25 at the ends of the conductor pairs 16 and 18 after installation. Hence, the conventional jumper cable apparatus is too complex and too difficult to use. In view of the above-mentioned drawbacks, U.S. Pat. No. 6,262,492 disclosed a simple and safe car battery jumper cable, which can automatically recognize voltage polarity when installed, enabling a power source to be accurately coupled to the exhausted car battery and the patent was approved on Jul. 17, 2001.

### SUMMARY OF THE INVENTION

It is therefore an objective of the present invention to provide a car battery jumper cable apparatus for examining whether polarity of a supplementary power source battery and an exhausted car battery is correctly connected. The jumper cable apparatus includes a relay, a relay driving circuit, a battery polarity recognition circuit, a signal oscillator, an alarm circuit of reverse battery polarity, an indicator light for showing discharged battery connection, and an indicator light for recharged battery connection. In addition, the signal oscillator will control a battery recharge procedure according to immediate recharged current status, so as to provide secure protection for recharge. The car battery jumper cable apparatus includes a very low cost and simple circuit, that, even when a relay causes a short circuit due to an incorrect usage, the car battery jumper cable apparatus still can work.

### BRIEF DESCRIPTION OF THE DRAWINGS

FIG. 1 is a circuit block diagram of the present invention.

FIG. 2 is a circuit diagram of the present invention.

FIG. 3 is a preferred embodiment diagram of U.S. Pat. No. 4,769,586.

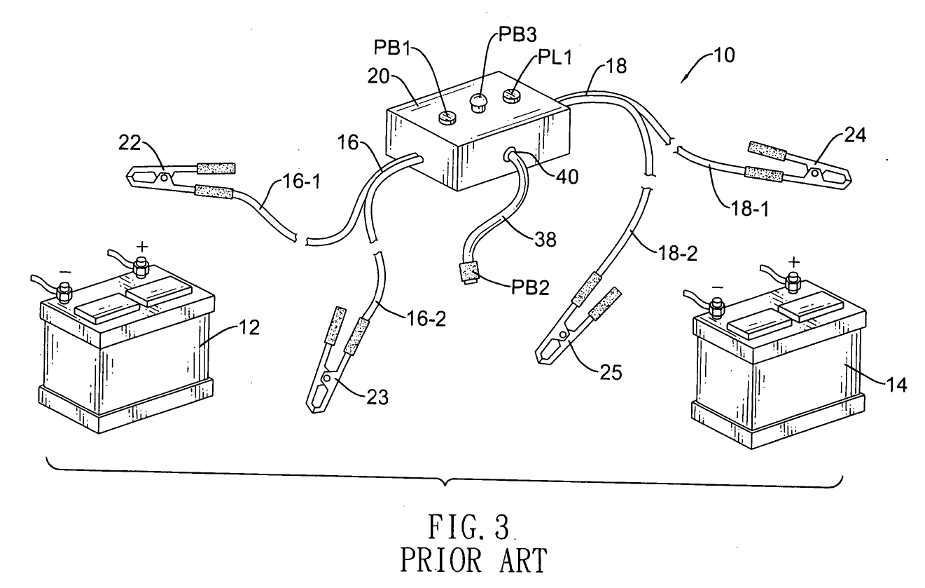

### DETAILED DESCRIPTION OF THE INVENTION

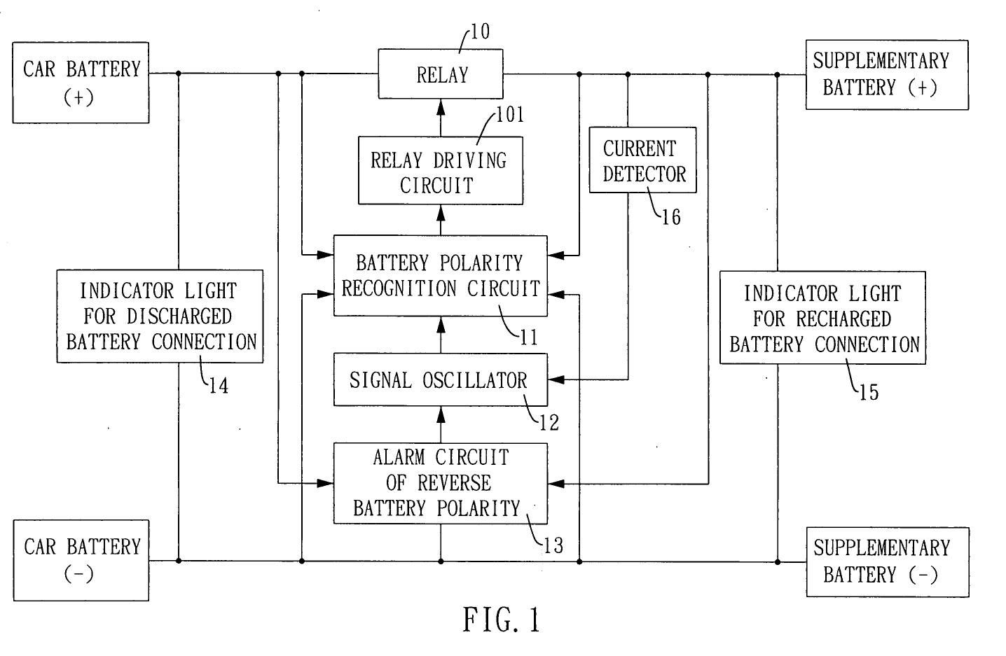

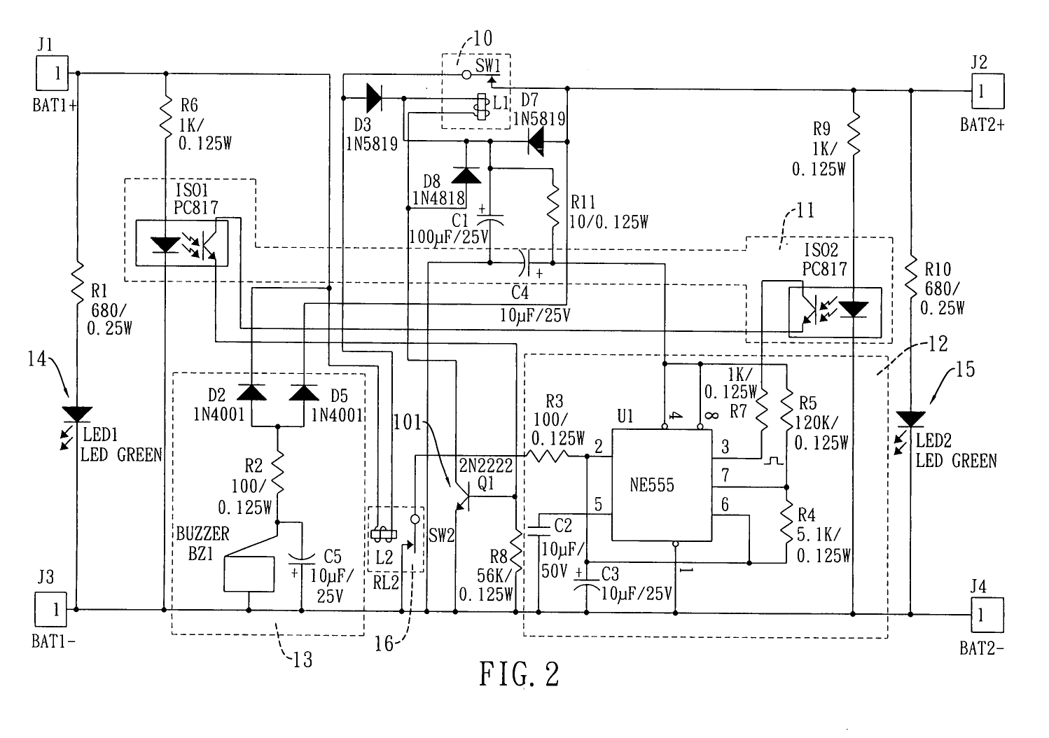

Referring to FIG. 1 and FIG. 2, an internal circuit diagram of a car battery jumper cable apparatus of the present invention is shown. The circuit includes four polarity poles of a clip formed as a first positive pole BAT1+ and a first negative pole BAT1− to be fitted to an exhausted car battery (hereinafter, car battery) and a second positive pole BAT2+ and a second negative pole BAT2− to be fitted to a supplementary power source battery (hereinafter, supplementary battery). The car battery jumper cable apparatus includes a relay 10 having an exciter coil L1 and a switch SW1. The switch SW1 is coupled between the pole BAT1+ of the car battery and the pole BAT2+ of the supplementary battery.

A relay driving circuit 101 is coupled to the exciter coil L1 of the relay 101. The relay driving circuit 101 can be an electronic switch, such as all kinds of transistors Q1 and so on.

A battery polarity recognition circuit 11 is coupled between the pole BAT1+ of the car battery and the pole BAT2+ of the supplementary battery for examining whether the pole of the car battery is correctly connected to the pole of the supplementary battery. An output terminal of the battery polarity recognition circuit 11 is coupled to the relay driving circuit 101 to control whether the relay 10 is excited. The battery polarity recognition circuit 11 comprises two optical couplers ISO1 and ISO2. A photodiode of a first optical coupler ISO2 is coupled between the positive pole BAT2+ and the negative pole BAT2− of the supplementary battery. A phototransistor of the first optical coupler ISO2 is coupled to a phototransistor of a second optical coupler ISO1. A photodiode of the second optical coupler ISO2 is cross-connected between the positive pole BAT1+ and the negative pole BAT1− of the car battery. Moreover, an emitter of the second optical coupler ISO1 is coupled to an emitter and a base resistance of the transistor Q1.

A signal oscillator 12 is provided. An oscillation-enabled terminal is coupled between the pole BAT1+ of the car battery and the pole BAT2+ of the supplementary battery by a current detector 16 to examine an immediate recharged current status. An output terminal is coupled to the battery polarity recognition circuit 11 to determine a starting period of the first optical coupler ISO2 along with the recharged current status. If polarity of the two batteries is correctly connected prior to current flowing or having the current lower than power supply current, the oscillation-enabled terminal of the signal oscillator 12 will be enabled to output an oscillation pulse wave signal to the battery polarity recognition circuit 11. If the current detector detects stable recharged current, the oscillation-enabled terminal will be disabled. Thus an electrical potential is outputted to the battery polarity recognition circuit 11, so as to make the relay 10 remain in an excited status.

The signal oscillator 12 comprises a 555 oscillator U1. An output terminal of the oscillation pulse wave signal is connected to a collector of the first optical coupler ISO2 of the battery polarity recognition circuit. The current detector 16 is a reed relay RL2. An exciter coil L2 of the reed relay is coupled between the pole BAT1+ of the car battery and the pole BAT2+ of the supplementary battery, and a switch SW2 of the reed relay RL2 is coupled between an oscillation-enabled terminal 2 of the 555 oscillator U1 and a ground terminal. When the reed relay RL2 gains a sufficient current to flow by the exciter coil L2, the switch SW2 makes the oscillation-enabled terminal connect to the ground terminal to gain a low electrical potential, so that the 555 oscillator U1 continues to output high electrical potential to the collector of the phototransistor of the first optical coupler ISO2.

An alarm circuit of reversed battery polarity 13 is coupled between the pole BAT1+ of the car battery and the pole BAT2+ of the supplementary battery. A warning sounds when the coupled battery polarity BAT1+, BAT1− of the car battery and BAT2+, BAT2− of the supplementary battery is reverse connected. The alarm circuit of reverse battery polarity 13 comprises a buzzer BZ1 and two parallel connected reverse diodes D2 and D5. The buzzer BZ1 is connected to the pole BAT1+ of the car battery and the pole BAT2+ of the supplementary battery by the reverse diodes D2 and D5 respectively.

An indicator light for discharged battery connection 14 comprises a light-emitting diode LED 1. An anode and a cathode of the light-emitting diode LED 1 are coupled to the positive pole BAT1+ and negative pole BAT1+ of the car battery respectively.

An indicator light for recharged battery connection 15 comprises a light-emitting diode LED2. An anode and a cathode of the light-emitting diode LED2 are coupled to the positive pole BAT2+ and negative pole BAT2− of the car battery respectively.

Referring to FIG. 2, emergency power rescue procedures are described as follows.

Firstly, the exhausted car battery and the supplementary battery are connected to respective ends of the car battery jumper cable. Since the car battery still has a little power, when it is connected to one end of the car battery jumper cable, the LED1 of the indicator light for discharged battery connection will light up if the connected polarity is correct. On the contrary, if the connected polarity is incorrect, the buzzer BZ1 of the alarm circuit of reversed battery polarity will make warning sounds. Vehicle users can follow the light and sound indication to connect the correct polarity of the car battery with the BAT1+ and BAT1− of the apparatus. By the same way, if the correct polarity of the supplementary battery is connected with the BAT2+ and BAT2− of the apparatus of the present invention, the LED2 indicator light for recharged battery connection will light up, while if the connected polarity is incorrect, the buzzer BZ1 of the alarm circuit of reverse battery polarity will make warning sounds. In this way, the vehicle users can confirm whether the connected polarity is correct or not before beginning the recharge.

If the vehicle users neglect the indication light and warning sound and mis-connect the polarity of the car battery and the supplementary battery, the car battery jumper cable apparatus of the present invention still can ensure the two batteries will not begin re-charging. Since the light-emitting diodes of the first optical coupler ISO2 and the second optical coupler ISO1 are connected with every polarity in the same direction, the first optical coupler ISO2 and the second optical coupler ISO1 will not work if the polarity of the two batteries is reversely connected. When the polarity of the car battery and the supplementary battery are correctly connected, the first optical coupler ISO2 and the second optical coupler ISO1 are able to work. Besides, the 555 oscillator U1 will start to output the oscillation pulse wave signal. Thereby when the 555 oscillator U1 outputs the oscillation pulse wave signal, the first optical coupler ISO2 will become lit by the light-emitting diode. In addition, since the collector of the phototransistor is coupled to an output terminal of the 555 oscillator U1, the phototransistor causes current to not flow. Because the phototransistor of the first optical coupler ISO2 and the phototransistor of the second optical coupler ISO1 are connected, despite the polarity of the phototransistor of the second optical coupler ISO1 being correctly connected to the car battery, the phototransistor of the second optical coupler ISO1 also causes current to not flow. The current of the phototransistor of the second optical coupler ISO1 will be inputted to the emitter resistance R8 to the transistor Q1, so as to make the transistor Q1 gain a bias voltage to be electrified and generate amplified current.

Since the collector of the transistor Q1 is connected with the exciter coil L i, when the transistor Q1 is electrified, the relay 10 makes periodic start and close movement along with the period of the pulse wave signal of the 555 oscillator U1 . If the potential difference of the car battery and the supplementary battery is high, at the moment of the relay 10 becomes electrified, a recharged current between the car battery and the supplementary battery will be generated. If the recharged current is greater than the excited current of the reed relay RL2, the switch SW2 of the reed relay RL2 will disable the oscillation-enabled terminal of the 555 oscillator U1. Thus a high electrical potential is continuously outputted to the battery polarity recognition circuit 11, so as to make the relay continue to be electrified to execute recharge.

When the car battery and the supplementary battery start to undergo the recharging process, but the current becomes excessive due to abnormal situations such as the vehicle ignition attempts last for more than the normal 15 seconds, a connecting point of the switch SW1 of the relay 10 will become welded and cause a short circuit. In such a situation, the present invention still includes general jumper cable functions. That is, when the car battery and the supplementary battery are correctly connected, the relay 10 still can be electrified, so as to make the car battery and the supplementary battery undergo the recharging process.

According to the above description, the present invention provides a clear instruction to guide the users to connect the polarity of the exhausted car battery and the supplementary battery, so as to perform the recharge successfully. Even if the main components of the present invention are burnt out due to abnormal excess current, the present invention still can provide the functions of the general jumper cable.

In addition, the signal oscillator of the present invention mainly provides a secure emergent rescue objective. That is, the conventional jumper cable includes four poles of a clip form design. If the poles are detached and cause a contact short, at this moment, the current detector will make the signal oscillator recover to output the oscillation signal due to disconnection of the supplied current. When the oscillation signal is at low electrical potential, no current flows by the phototransistor of the optical coupler. Besides, due to the clip(s) being detached, the light-emitting diode of the optical coupler will not be electrified nor lit. Thereby despite the signal oscillator outputting a high electrical potential again, the optical coupler will not be electrified any more, so that the relay will not be shorted. In this way, the present invention definitely can provide secure emergent rescue power supply efficiency.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A car battery jumper cable apparatus having a first positive pole and a first negative pole to be fitted to an exhausted car battery and a second positive pole and a second negative pole to be fitted to a supplementary power source battery, wherein the apparatus comprises:
a relay comprising an exciter coil and a switch, wherein the switch is coupled between the pole of the exhausted car battery and the pole of the supplementary battery;
a relay driving circuit coupling to the exciter coil of the relay for controlling whether current flows to the exciter coil of the relay;
a battery polarity recognition circuit coupling between the pole of the exhausted car battery and the pole of the supplementary battery for examining whether the pole of the exhausted car battery is correctly connected to the pole of the supplementary battery, and wherein an output terminal of the battery polarity recognition circuit is coupled to the relay driving circuit to control whether the relay is excited;
a signal oscillator wherein an oscillation-enabled terminal is coupled between the pole of the exhausted car battery and the pole of the supplementary battery by a current detector to examine an immediate recharged current status, and wherein an output terminal is coupled to the battery polarity recognition circuit to determine whether to output an oscillation pulse wave signal to the battery polarity recognition circuit along with-the recharged current status;
an alarm circuit of reverse battery polarity coupling between the pole of the exhausted car battery and the pole of the supplementary battery, wherein a warning sounds when the coupled battery polarity of any end of a cable is reversed in relation to a required fitting;
an indicator light for discharged battery connection comprising a first light-emitting diode, wherein an anode and a cathode of the first light-emitting diode are coupled to the positive pole and negative pole of the exhausted car battery respectively; and
an indicator light for recharged battery connection comprising a second light-emitting diode, wherein an anode and a cathode of the second light-emitting diode are coupled to the positive pole and negative pole of the exhausted car battery.

2. The battery jumper cable apparatus as claimed in claim 1, the battery polarity recognition circuit comprising a first optical coupler and a second optical coupler, each of the optical couplers having a photodiode and a phototransistor;
the photodiode of the first optical coupler coupled between the positive pole and the negative pole of the supplementary battery;
the phototransistor of the first optical coupler coupled to the phototransistor of the second optical coupler, and further coupled to an output terminal of the signal oscillator;
the photodiode of the second optical coupler connected between the positive pole and the negative pole of the exhausted car battery.

3. The battery jumper cable apparatus as claimed in claim 2, wherein the signal oscillator comprises a 555 oscillator, wherein an output terminal of the oscillation pulse wave signal is connected to a collector of the first optical coupler of the battery polarity recognition circuit, wherein the current detector is a reed relay, wherein an exciter coil of the reed relay is coupled between the pole of the exhausted car battery and the pole of the supplementary battery, and a switch of the reed relay is coupled between the oscillation-enabled terminal of the 555 oscillator and a ground terminal, and wherein when the current detector detects the recharged current, the switch makes the oscillation-enabled terminal input and connect to the ground terminal, so that the 555 oscillator continues to output high electrical potential to the collector of the phototransistor of the first optical coupler.

4. The battery jumper cable apparatus as claimed in claim 1, wherein the alarm circuit comprises a buzzer and two reverse diodes connected in parallel, and the buzzer is connected to two terminals of the cable by the reverse diodes respectively.

5. The battery jumper cable apparatus as claimed in claim 2, wherein the alarm circuit comprises a buzzer and two reverse diodes connected in parallel, and the buzzer is connected to two terminals of the cable by the reverse diodes respectively.

6. The battery jumper cable apparatus as claimed in claim 3, wherein the alarm circuit comprises a buzzer and two reverse diodes connected in parallel, the buzzer is connected to two terminals of the cable by the reverse diodes respectively.

7. The battery jumper cable apparatus as claimed in claim 2, wherein the relay driving circuit is a transistor, an emitter and a base of the transistor is connected with a resistor, the resistor is connected to the phototransistor of the second optical coupler, and a collector of the transistor is coupled to the exciter coil of the relay.

8. The battery jumper cable apparatus as claimed in claim 1, wherein the poles of the exhausted car battery and the poles of the supplementary battery are of a clip form.
